(19) United States
(12) Patent Application Publication
(10) Pub. No.: US 2014/0261954 A1
(43) Pub. Date: Sep. 18, 2014

(54) METHOD OF PREPARING MAT-FACED ARTICLE

(71) Applicant: UNITED STATES GYPSUM COMPANY, Chicago, IL (US)

(72) Inventors: Ashish DUBEY, Grayslake, IL (US); Yanfei PENG, Gurnee, IL (US); David BLACKBURN, Barrington, IL (US)

(73) Assignee: UNITED STATES GYPSUM COMPANY, Chicago, IL (US)

(21) Appl. No.: 13/837,041

(22) Filed: Mar. 15, 2013

(51) Int. Cl. B32B 38/00

(52) U.S. Cl. CPC B32B 38/0012
USPC 156/45

(57) ABSTRACT

Disclosed is a method of preparing a mat-faced cementitious article composite. A mat-faced article (e.g., board) is formed and the composite is formed upon application of a finish composition (e.g., hydrophobic). In one aspect, the mat-faced gypsum article comprises a mat having an inner surface adjacent to a cementitious core first surface and an opposite outer mat surface. An aqueous cementitious finish composition is applied to the outside mat surface to form the mat-faced cementitious article composite. Desirably, the finish composite can suitably be applied by a roller assembly comprising a finish roller. In some embodiments, the finish roller has an uneven surface, including for example, grooves or depressions (e.g., circumferential or longitudinal) defined therein.

### BACKGROUND OF THE INVENTION

Cementitious articles, such as gypsum board and cement board, are useful in a variety of applications, some of which require a degree of water resistance. Traditional paper-faced cementitious articles do not always perform well under high moisture conditions, or upon exposure to the outdoors. Thus, for such applications, it is often desirable to use a cementitious article that is faced with a glass or polymer-based fiber mat instead of paper. It also is advantageous to use additives in the cementitious core that improve the water resistance of the core material itself.

The manufacturing process of cementitious articles, such as gypsum board and cement board, typically involves depositing a cementitious slurry over a first facing material and covering the wet slurry with a second facing material of the same type, such that the cementitious slurry is sandwiched between the two facing materials. Thereafter, excess water is removed from the slurry by drying. The cementitious slurry is allowed to harden to produce a solid article prior to final drying.

The manufacturing process of cementitious articles, thus, often requires the facing material to be sufficiently permeable that excess water can be removed from the cementitious slurry in the drying process. A drawback is that the permeability of the fibrous mat facing material also reduces the water-resistance of the cementitious article because it allows water to penetrate the mat and contact the cementitious core during use. It has been found to be difficult to prepare mat-faced cementitious articles (e.g., board) with sufficient water penetration resistance.

Thus, there remains need for improved methods of preparing such articles with water penetration resistance.

### BRIEF SUMMARY OF THE INVENTION

In one aspect, the invention provides a method of preparing a mat-faced cementitious article composite. The method comprises preparing a mat-faced gypsum article, wherein the mat has an inner surface adjacent to a cementitious core and an opposite outer surface. An aqueous cementitious finish composition is applied to the outside surface to form the mat-faced cementitious article composite. In some embodiments, the finish composition is applied with a roller assembly. The roller assembly comprises a finish roller for depositing the finish composition on the outer surface of the fibrous mat. For example, the finish roller can have an uneven surface, such as by way of at least one groove defined in the finish roller surface.

### BRIEF DESCRIPTION OF THE SEVERAL VIEWS OF THE DRAWING(S)

FIG. 1A is a schematic side view illustrating a roller assembly comprising a finish roller with circumferential grooves defined therein applying a hydrophobic finish composition to a mat-faced cementitious board with the assembly in a direct finish orientation, in accordance with embodiments of the invention.

FIG. 1B is a front schematic view of the roller assembly taken along the line 1B-1B depicted in FIG. 1A.

FIG. 2A is a schematic side view illustrating a roller assembly comprising a finish roller with circumferential grooves defined therein applying a hydrophobic finish composition to a mat-faced cementitious board with the assembly in a reverse finish orientation, in accordance with embodiments of the invention.

FIG. 2B is a front schematic view of the roller assembly taken alone the line 2B-2B depicted in FIG. 2A.

FIG. 3 is a graph of drop in water level (inches) versus time (days), which illustrates the effect of scraping on the water penetration resistance of glass mat gypsum panel having hydrophobic finish that includes grit.

FIG. 4 is a graph of drop in water level (inches) versus time (days) for comparative purposes, which illustrates the inadequate water resistance for glass mat gypsum panel with hydrophobic finish applied with a finish roller having a smooth surface.

FIG. 5 is a photograph illustrating inadequate water resistance as seen by the presence of water droplet on sample 3A from Example 3 after water absorption testing, for comparative purposes.

FIG. 6 is a optical microscopy image at 25× magnification for comparative purposes, which illustrates the presence of undesirable voids in the hydrophobic finish of a glass mat panel thereby resulting in poor water resistance.

FIG. 7 is a graph of drop in water level (inches) versus time (days), which illustrates improved water resistance for glass mat gypsum panel with hydrophobic finish applied with a finish roller having an uneven surface in accordance with embodiments of the invention.

FIGS. 8A and 8B are optical microscopy images at 25× magnification depicting hydrophobic finish of sample 4F from Example 4 (FIG. 8A) and sample 4A from Example 4 (FIG. 8B).

FIG. 9 is a graph of drop in water level (inches) versus time (days), illustrating improved water resistance for glass mat gypsum panel with hydrophobic finish applied with a finish roller having an uneven surface in accordance with embodiments of the invention.

FIGS. 10A, 10B, and 10C are optical microscopy images at 20× magnification depicting hydrophobic finish of sample 5A from Example 5 (FIG. 10A), sample 5C from Example 5 (FIG. 10B), and sample 5E from Example 5 (FIG. 10C).

FIGS. 11A and 11B are graphs plotting the relative moisture readings versus total time in oven (seconds) of composite articles, which illustrate the effect of varying drying temperatures and durations.

FIG. 12 is a graph of drop in water level (inches) versus time (days), which illustrates the effect of varying drying temperatures and durations on water resistance for glass mat gypsum panel with hydrophobic finish.

### DETAILED DESCRIPTION OF THE INVENTION

The present invention provides a method of preparing a mat-faced cementitious article composite. In accordance with embodiments of the invention, to form the composite, a mat-faced article (e.g., board) is formed. A finish composition (e.g., hydrophobic) is applied to the article to form the article composite.

In one aspect, the mat-faced gypsum article comprises a mat having an inner surface adjacent to a cementitious core and an opposite outer surface. An aqueous cementitious finish composition is applied to the outside surface to form the mat-faced cementitious article composite. Desirably, the finish composite can suitably be applied by a roller assembly comprising a finish roller. In some embodiments, the finish roller has an uneven surface, including, for example, grooves or depressions (e.g., circumferential or longitudinal) defined therein.

One exemplary embodiment for applying finish composition to a mat-faced board (e.g., gypsum board) is depicted in FIGS. 1A-1B, which show a direct application orientation of a roller assembly 100 such that a finish roller 110 rotates in the same direction that the mat-faced board 112 travels as described below. Thus, the finish roller 110 rotates in a direction so that its surface moves in the same direction as the board moves. By way of contrast, in reverse finishing configurations, described below in connection with FIGS. 2A-2B, the finish roller rotates in reverse so that its surface in contact with the board is moving in the opposite direction that the board moves.

Roller assembly 100 also includes a doctor roller 114 which engages with finish roller 110. Rollers 110 and 114 are mounted with brackets that are journaled to allow for rotation and extend from columns mounted on the building floor or table on which the board travels. One or both of the rollers 110 and 114 are driven by a motor. In some embodiments, the finish roller 110 and doctor roller 114 are driven, e.g., by independent, variable speed, drive assemblies. This can be advantageous in some embodiments to allow the finish roller 110 speed and doctor roller 114 speeds to be varied independently, as desired. In other embodiments, one of the rollers 110 or 114 is driven while the other roller 110 or 114 is an idler such that it rotates by engagement with the driven roller such that it rotates in response to the roller being driven.

The doctor roller 114 engages with the finish roller 110. Particularly, the doctor roller 114 mates with the finish roller 110 to form a trough between the two, where the finish composition is introduced. The finish roller 110 and the doctor roller 114 generally counter-rotate, i.e., rotate in opposite directions relative to one another, both in direct finishing or reverse finishing configurations (described below). Having the finish roller 110 and doctor roller 114 engage in this manner facilitates keeping the slurry in the gap between the two rollers so that so that the slurry does not spill. The position of the doctor roller 114 is adjusted relative to the finish roller 110. This may result in a small gap between the two rollers, which can be adjusted to control the amount of slurry allowed to pass between them, which in turn influences the amount of finishing composition to be applied. In some embodiments, particularly in direct finishing arrangement, this gap may actually be negative indicating an interference fit as that term is understood in the art, thereby indicating that the doctor roller 114 is touching, and compressing the surface of, the finish roller 110.

As best seen in FIG. 1B, the finish roller 110 includes grooves 116 that are circumferentially disposed in the surface of the finish roller 110. In the direct application orientation, doctor roller 114 is upstream of finish roller 110 to minimize the surface area of finish roller 110 bearing the finish composition. In this respect, it has been found that increasing the surface area (beyond, e.g., 90°, 100°, 120°, etc) of the portion of finish roller 110 that bears finish composition increasingly results in undesirable variation in the finish application. A top surface 118 of the board 112 as shown is adjacent to the finish roller 110. A bottom roller 120 is disposed under a bottom surface 122 of the board 112. The board is generally supported by a roller conveyor, chain conveyor, belt conveyor, or the like at the pass line height, i.e., the same elevation as the top of the bottom roller 120. For example, the bottom roller 120 can optionally work in concert with other rollers which help transport board into and out of the assembly roller 100.

Finish composition is dispensed between finish roller 110 and doctor roller 114 to feed the composition between the finish roller 110 and doctor roller 114 and onto the surface of the finish roller 110 for application to top surface 118 of board 112. A head 124 of the finish composition slurry forms between the doctor roller 114 and the finish roller 110. The head can be controlled by sensor such as laser control as understood in the art. The surface of the finish roller 110 pulls finish composition onto the board 112 to deposit the finish composition onto the top surface 118 to lay a finish 126 and form a composite 128. The bottom roller 120 provides underlying support and is generally aligned under the finish roller 110.

Another exemplary embodiment for applying a finish composition to a mat-faced board (e.g., gypsum board) is depicted in FIGS. 2A-2B, which show a reverse application orientation of a roller assembly 200 such that a finish roller 210 rotates in the opposite or counter direction that the mat-faced board 212 travels. Roller assembly 200 includes a doctor roller 214 which engages with finish roller 210 in counter-rotation. As best seen in FIG. 2B, the finish roller 210 includes grooves 216 that are circumferentially disposed in the surface of the roller 210. In the reverse application orientation, doctor roller 214 is downstream of finish roller 210 to minimize the surface area of the finish roller 210 that bears the finish composition. A top surface 218 of the board 212 as shown is adjacent to the finish roller 210. A bottom roller 220 is disposed under a bottom surface 222 of the board 212. The bottom roller 220 may have a cover formed from, for example, rubber or elastomeric material such as neoprene, to achieve traction on the bottom surface 222, to ensure board travels at the desired speed and desired direction, despite the frictional force of the finish roll 210.

Finish composition is dispensed between finish roller 210 and doctor roller 214. A head 224 of the finish composition slurry forms between the doctor roller 214 and the finish roller 210. The finish roller 210 acts to apply the finish composition onto the top surface 218 to lay a finish 226 and form a composite 228. Other aspects of the embodiment set forth in FIGS. 2A-2B, such as driver for the roll, the mounting thereof, and the presence of other bottom rollers, are similar to the description set forth relative to FIGS. 1A-1B as described above.

Generally, in both embodiments depicted in FIGS. 1-2, doctor roller 114 or -214 has a smaller diameter than finish roller 110 or 210 because the highest elevation of both the doctor roller 114 and finish roller 110 typically is at the same elevation (or with axes at substantially coinciding elevation), and the lowest elevation of the doctor roller 114 or 214 should be higher than the surface to be finished, to avoid interference with the article being finished. The grooves 116 and 216 can be in any suitable configuration. For example, the finish roller 110 or 210 can comprise a buttress thread form to define the grooves in some embodiments. In embodiments including the buttress thread configuration, any suitable buttress thread count per longitudinal inch of the roller can be used.

In these and other embodiments, each roller piece in the roller assembly can be independently driven and varied to allow fine tuning the finishing. As noted herein, the bottom roller can optionally be a part of a larger section of rollers used in conveyors for moving board down a manufacturing line. For example, in some embodiments, a series of rollers can be driven with one drive and linked together (e.g., with chains, belts, or the like). However, in some embodiments, the bottom roller can have its speed independently varied relative to other conveying rollers to thereby allow more precise control of the bottom roller of the roller assembly of embodiments of the invention, e.g., so as to regulate the speed of the bottom roller to correspond with the speed of the board.

The bottom roller in accordance with embodiments of the invention is a supporting roller opposing the finish roller. For example, the finish roller advantageously can keep the board being treated with finish composition at the desired elevation (path line height) while also enhancing traction to drive the board in the proper direction and substantially constant rate down the manufacturing line. The bottom roller further facilitates having an even finish thickness on the outer surface of the board. For example, the roller reduces the chance for roller slippage over the board to which the finish is being applied. Such slippage can undesirably result in variation in thickness of the applied finish composition. In some embodiments, as an alternative to a bottom roller, a plate such as an anvil plate can be used.

The vertical gap between the finish roller and bottom roller can be adjusted to accommodate different clearances between them, e.g., to accommodate different board thickness. In some embodiments, the bottom roller remains stationary while the finish roller is moved up and down to adjust the gap. However, other variations are possible, including having the height of the bottom roller adjustable or having both the finish roller and the bottom roller being adjustable.

The doctor roller typically is formed at least in part with suitable metal. For example, in some embodiments, the metal is steel such as stainless steel to avoid rusting given that the finish composition is normally in the form of aqueous slurry. The surface can be plated with chrome or the like to allow the doctor roller to remain as clean as possible in operation.

The composition of the finish roller may vary, e.g., depending on whether a direct finishing or reverse finishing arrangement is employed. For example, in some embodiments of a direct finishing arrangement, the finish roller can be formed of metal with a softer cover such as formed from one or more rubbers or elastomeric material such as neoprene, ethylene propylene diene monomer (EDPM) rubber, or the like. In this respect, it is understood that the article to be finished, including mat-faced board, are not perfectly flat because of, e.g., surface imperfections. Thus, in accordance with embodiments of the invention, a cover (e.g., made of rubber material) can be used to conform to surface imperfections in the board or other article to allow for an even more finish. Rubbers are desirable materials for this purpose because of compressibility property and long wear life. They also tend to be materials that are easy to keep clean. The use of a steel finish roller can be less desirable in some embodiments of direct finishing arrangements. For example, where surface imperfections are prevalent, a steel finish roller is less apt to conform to the surface. The applied finish will have variation with a thicker finish being observed where there are depressions in the board surface and a thinner finish observed where there are protrusions in the board surface.

However, in some embodiments, such as some reverse finish arrangements, the finish roller can be formed from metal such as steel to reduce wear. In this respect, where the finish roller is rotating in a direction opposite as the board is traveling, the finish roller will exhibit undesirable wear characteristics in operation if the finish roller is made of softer material such as rubber. Furthermore, a rubber finish roller may at times create excessive traction such that the board undesirably could be pushed backwards.

It will be understood that the grooves, if present, can be in any suitable configuration. Grooves advantageously allow for more surface area for finish to be applied. The grooves can be cut into the rubber cover and/or into a metal roller in various embodiments, with grooves being particularly advantageous in rubber covered embodiments of finish roller because rubber in some embodiments is easier to clean. In some embodiments, the finish roller comprises a buttress thread form to define the grooves in some embodiments. In embodiments including the buttress thread configuration, any suitable buttress thread count per longitudinal inch of the roller can be used. For example, in some embodiments, the finish roller has from about 4 to about 50 buttress thread per inch of longitude, such as from about 8 to about 12 buttress thread per inch, e.g., about 10 buttress thread per inch.

In some embodiments, the finish roller has a longitudinal axis and the groove(s) are circumferential such that they are perpendicular, or nearly perpendicular, to the axis. The grooves can have any suitable depth, such as a depth from about 0.001 inch to about 0.25 inch, e.g., from about 0.05 inch to about 0.20 inch. The grooves can have any suitable width, for example, from about 0.001 inch to about 0.25 inch, such as from about 0.08 inch to about 0.012 inch.

The size of the rollers can vary. For example, the radius of the finish roller is dependent on the line speed of the article being finished, and the viscosity of the finish composition. The length of the finish roller is dependent on the width of the panels being finished and normally the length of the roller is somewhat longer than the width of the product, e.g., 10 to 15% longer, for example, to ensure the product is finished across the entire width. The radius of the doctor roller may be dependent on the radius of the finish roller, speed of doctor roller, finish viscosity, etc. In some embodiments, the doctor roller has a smaller diameter than the finish roller so that its axis is substantially the same elevation as the axis of the finish roller, while its bottom surface is above the top surface of the panel 218. The length of the doctor roller should normally be the same as the length of the finish roller, with dams on the ends of these rollers, to prevent slurry from spilling over.

The finish roller is normally fabricated from steel, and can have one or more covers with any suitable hardness. In some embodiments, the hardness of the finish roller is selected to be softer than the doctor roller to allow the doctor roller to compress the finish roller as the rollers engage which is advantageous in Controlling the amount of finish composition to be deposited. For example, the cover(s) can be such that the finish roller can have a hardness of about 100 Durometer or less as determined according to Shore-A, such as about 70 Durometer Shore-A or less, e.g., about 40 Durometer Shore-A, with the doctor roller desirably having higher corresponding hardness value than the selected value for the finish roller in some embodiments. If desired, the finish roller cover(s) comprises neoprene, EPDM, or a combination thereof to help reduce surface hardness while maintaining a harder core in some embodiments. For direct finish configurations, desirably the finish roller can be formed from rubber in order to allow if to conform to the imperfect surface of the board, resulting in a more uniform finishing thickness. In reverse finish configurations, a roller with no cover can be used in some embodiments, e.g., a chrome-plated smooth steel finish roller because this allows for greater resistance to wear, while also minimizing frictional force against the top surface of the board 218, and minimizing the amount of finishing adhering on the roller surface.

The gap between adjacent surfaces of the doctor roller and finish roller in some embodiments are in an interference fit such that the gap is defined by a negative number as understood in the art. The negative numbers refer to the amount of interference, for example, the difference between the sum of the outmost radii of the finish roller and the doctor roller, and the actual distance between axes of these two rollers. In some embodiments where the finish roller is generally softer than the doctor roller, the doctor roller can compress the finish roller when the rolls are positioned this way. The gap between the doctor roller and finish roller may be adjusted depending on factors including the viscosity of the finishing composition, the speed of the rollers, and whether direct or reverse roller configurations are employed. In direct roller finishing, the finish roller and the doctor roller are disposed to define a gap therebetween in some embodiments from about +0.010 inch (≈+0.025 cm) to about −0.020 inch (≈−0.051 cm), such as from about −0.005 inch (≈−0.013 cm) to about −0.010 inch (≈−0.025 cm), e.g., about −0.007 inch (≈−0.018 cm). In reverse finishing arrangements, the gaps can be somewhat larger, e.g., from zero to about +0.010 inch in some embodiments.

In some embodiments, the roller assembly is configured such that a gap between the finish roller and the bottom roller is less than the average panel thickness by about 0 inch (≈0 cm) to about 0.10 inch (≈0.25 cm), such as by about 0.01 inch (≈0.25 cm) to about 0.08 inch (≈0.20 cm), e.g., by about 0.02 inch (≈0.51 cm) to about 0.06 inch (≈0.15 cm).

Any suitable finish composition can be applied to cementitious articles, e.g., on an outer surface of a fibrous mat to form the article composite. In some embodiments, the finish is hydrophobic. For example, the hydrophobic finish in accordance with some embodiments can include Class C fly ash, film forming polymer, and silane compound as described in corresponding, commonly-assigned U.S. patent application Ser. No. 13/834,556, filed on Mar. 15, 2013, entitled “Cementitious Article Comprising Hydrophobic Finish,” incorporated herein by reference. Other examples of finish compositions that can be used in various embodiments of the present are described, e.g., in U.S. Pat. No. 8,070,895; and U.S. Patent Publication 2010/0143682.

The finish composition can be prepared in any suitable manner, including as described in commonly-assigned U.S. patent application Ser. No. 13/834,556, filed on Mar. 15, 2013, entitled “Cementitious Article Comprising Hydrophobic Finish,” U.S. Pat. No. 8,070,895; and U.S. Patent Publication 2010/0143682. For example, the finish composition can be formed as a slurry comprising cementitious material (e.g., fly ash or the like), as well as additives as desired. In some embodiments, the slurry is formed in a mixer. The mixer can provide any suitable mixing parameters, which can be continuous if desired. In some embodiments, the mixing is by continuous mixing with a twin screw, e.g., a continuous, co-rotating overlapping twin screw mixer.

It has been found that, in some embodiments, the finish composition can contain grit primarily due to the presence of coarse particles in the raw materials. When grit is present, it is desirable to remove the grit. For example, in some embodiments, one or more components of the slurry, or the whole slurry for that matter, can be passed through a screen having a size from about 12 mesh to about 100 mesh, such as from about 20 mesh to about 60 mesh, e.g., from about 30 mesh to about 40 mesh.

The finish composition can be applied in any suitable weight or density, or wet finish thickness. For example, in some embodiments, the finish composition is applied in an amount from about 10 lb/msf to about 200 lb/msf, such as from about 80 lb/msf to about 150 lb/msf, e.g., from about 120 lb/msf to about 140 lb/msf. The wet finish thickness will vary depending on the composition, e.g., and will depend on how much finish soaks into the mat as will be appreciated by one of ordinary skill in the art.

Desirably, the finish composition is applied with two or less passes under the finish roller. In some embodiments, the finish composition is applied with only one pass under the finish roller.

In one aspect, the finish composition is applied sufficiently to provide coverage over the entire mat without significant uncovered areas that would otherwise compromise the water resistance of the composite. Desirably, the article composite is formed into a board that passes the test for waterproofness per ANSI A118.10 (according to ASTM D4068) and/or a modified ANSI A118.10, wherein 48 inch hydrostatic pressure is applied for 48 hours, with a water level drop of about 1/32 inch or less.

After the finish is applied, it is dried. The applied finish can be dried in any suitable manner including air drying (i.e., without heat) or in a kiln (with heat). It is to be noted the cementitious article need not be fully dried (by way of kiln) prior to application of the finish to the outer mat surface, although it could be. Thus, in some embodiments, however, the finish roller is added in the gypsum board manufacturing process such that cementitious board would be finished prior to entering the kiln, and would exit the kiln as essentially a finished product without the need for an off-line finish and drying operation.

In some embodiments, the finish can be dried in an off-line process with a separate dryer after the finish roller applies the finish composition. For example, the applied finish can be dried with radiant and/or convection heating. In such embodiments, any sufficient heating time and duration can be used. For example, the heat can be provided at a temperature from about 200° F. (≈93° C.) to about 600° F. (≈316° C.), such as from about 350° F. (≈177° C.) to about 450° F. (≈233° C.). The time duration can vary depending on temperature and air flow and can be, for example, from about 15 seconds to about 120, such as from about 45 seconds to about 75 seconds.

If desired, in some embodiments the article can be preheated until the surface temperature is at least about 80° F. (e.g., about 100° F.), prior to applying the finish composition.

The fibrous mat comprises any suitable type of polymer or mineral fiber, or combination thereof. Non-limiting examples of suitable fibers include glass fibers, polyamide fibers, polyaramide fibers, polypropylene fibers, polyester fibers (e.g., polyethylene teraphthalate (PET)), polyvinyl alcohol (PVOH), polyvinyl acetate (PVAc), cellulosic fibers (e.g., cotton, rayon, etc.), and the like, as well as combinations thereof. Furthermore, the fibers of the mat can be hydrophobic or hydrophilic, finished or unfinished. Of course, the choice of fibers will depend, in part, on the type of application in which the cementitious article is to be used. For example, when the cementitious article is used for applications that require heat or fire resistance, appropriate heat or fire resistant fibers should be used in the fibrous mat.

The fibrous mat can be woven or non-woven; however, non-woven mats are preferred. Non-woven mats comprise fibers bound together by a binder. The binder can be any binder typically used in the mat industry. Suitable binders include, without limitation, urea formaldehyde, melamine formaldehyde, stearated melamine formaldehyde, polyester, acrylics, polyvinyl acetate, urea formaldehyde or melamine formaldehyde modified or blended with polyvinyl acetate or acrylic, styrene acrylic polymers, and the like, as well as combinations thereof. Suitable fibrous mats include commercially available mats used as facing materials for cementitious articles.

By way of further illustration, a non-limiting example of a suitable glass fiber mat comprises about 80-90 percent (e.g., about 83 percent) 16 micron diameter, ½-inch to 1-inch long (about 1.2-2.5 cm long) continuous filament fibers and about 10-20 percent (e.g., about 17 percent) biosoluble microfibers having about 2.7 nominal micron diameter (Micro-Strand® Type 481, manufactured by Johns Manville) with a basis weight of about 24 lbs/1000 ft². One suitable glass fiber mat is the DuraGlass® 8924G Mat, manufactured by Johns Manville. The binder for the glass mat can be any suitable binder, for example, styrene acrylic binder, which can be about 28% (+/−3%) by weight of the mat. The glass mat can include a colored pigment, for example, green pigment or colorant.

The cementitious article can be prepared by any suitable method, and the present invention is not limited by the manner in which the cementitious article is made. For example, embodiments of a method of preparing a fibrous mat-faced cementitious article comprise (a) depositing a cementitious core slurry on a first fibrous mat comprising polymer or mineral fibers, and (b) allowing the cementitious slurry to harden, thereby providing a fibrous mat-faced cementitious article. A second fibrous mat can be applied to the cementitious core slurry on an opposite surface as the first fibrous mat.

In some embodiments, the method of preparing a cementitious article in accordance with the invention can be conducted on existing gypsum board manufacturing lines used to make fibrous mat-faced cementitious articles known in the art. Briefly, the process typically involves discharging a fibrous mat material onto a conveyor, or onto a forming table adjacent to a conveyer, which is then positioned under the discharge conduit (e.g., a gate-canister-boot arrangement as known in the art, or an arrangement as described in U.S. Pat. Nos. 6,494,609 and 6,874,930) of a mixer. The components of the cementitious slurry are fed to the mixer comprising the discharge conduit, where they are agitated to form the cementitious slurry. Foam can be added in the discharge conduit (e.g., in the gate as described, for example, in U.S. Pat. Nos. 5,683,635 and 6,494,609). The cementitious slurry is discharged onto the fibrous mat facing material. The slurry is spread, as necessary, over the fibrous mat facing material and optionally covered with a second facing material, which may be a fibrous mat or other type of facing material (e.g., paper, foil, plastic, etc.). The wet cementitious assembly thereby provided is conveyed to a forming station where the article is sized to a desired thickness, and to one or more knife sections where it is cut to a desired length to provide a cementitious article. The cementitious article is allowed to harden, and, optionally, excess water is removed using a drying process (e.g., by air-drying or transporting the cementitious article through a kiln). Each of the above steps, as well as processes and equipment for performing such steps, are known in the art. It also is common in the manufacture of cementitious articles such as gypsum and cement board to deposit a relatively dense layer of slurry onto a facing material before depositing the primary slurry, and to use vibration in order to eliminate large voids or air pockets from the deposited slurry. Also, hard edges, as known in the art, are sometimes used. These steps or elements (dense slurry layer, vibration, and/or hard edges) optionally can be used in conjunction with the invention.

The cementitious core of the article can comprise any material, substance, or composition containing or derived from hydraulic cement, along with any suitable additives. Non-limiting examples of materials that can be used in the cementitious core include Portland cement, sorrel cement, slag cement, fly ash cement, calcium alumina cement, water-soluble calcium sulfate anhydrite, calcium sulfate alpha-hemihydrate, calcium sulfate beta-hemihydrate, natural, synthetic or chemically modified calcium sulfate hemihydrates, calcium sulfate dihydrate (“gypsum,” “set gypsum,” or “hydrated gypsum”), and mixtures thereof. As used herein, the term “calcium sulfate material” refers to any of the forms of calcium sulfate referenced above.

The additives can be any additives commonly used to produce cementitious articles, such as gypsum board or cement board. Such additives include, without limitation, structural additives such as mineral wool, continuous or chopped glass fibers (also referred to as fiberglass), perlite, clay, vermiculite, calcium carbonate, polyester, and paper fiber, as well as chemical additives such as foaming agents, fillers, accelerators, sugar, enhancing agents such as phosphates, phosphonates, borates and the like, retarders, binders (e.g., starch and latex), colorants, fungicides, biocides, and the like. Examples of the use of some of these and other additives are described, for instance, in U.S. Pat. Nos. 6,342,284, 6,632,550, 6,800,131, 5,643,510, 5,714,001, and 6,774,146, and U.S. Patent Publications 2004/0231916 A1, 2002/0045074 A1 and 2005/0019618 A1.

Preferably, the cementitious core comprises a calcium sulfate material, Portland cement, or mixture thereof. Advantageously, if desired, in some embodiments, the cementitious core also comprises a hydrophobic agent, such as a silicone-based material (e.g., a silane, siloxane, or silicone-resin matrix), in a suitable amount to improve the water resistance of the core material. It is also preferred that the cementitious core comprise a siloxane catalyst, such as magnesium oxide (e.g., dead burned magnesium oxide), fly ash (e.g., Class C fly ash), or a mixture thereof. The siloxane and siloxane catalyst can be added in any suitable amount, and by any suitable method as described herein with respect the method of preparing a water-resistant cementitious article of the invention, or as described, for example, in U.S. Patent Publications 2006/0035112 A1 or 2007/0022913 A1. Desirably, the cementitious core also comprises strength-improving additives, such as phosphates (e.g., polyphosphates as described in U.S. Pat. Nos. 6,342,284, 6,632,550, and 6,800,131 and U.S. Patent Publications 2002/0045074 A1, 2005/0019618 A1, and 2007/0022913 A1) and/or pre-blended unstable and stable soaps (e.g., as described in U.S. Pat. Nos. 5,683,635 and 5,643,510). The cementitious core can comprise paper or glass fibers, but is preferably substantially free of paper and/or glass fibers (e.g., comprises less than about 1 wt. %, less than about 0.5 wt. %, less than about 0.1 wt. %, or even less than about 0.05 wt. % of paper and/or glass fibers, or contains no such fibers). For the purposes herein, the core can include one or more dense skim coats and/or hard edges, as is known in the art.

The mat-faced cementitious article composite can further comprise a second fibrous mat on an opposite surface of the core, and the core can optionally comprise a skim coat in contact with the inner mat surface of one or both mats. In some embodiments, a second finish composition can be applied on an outer surface of the second fibrous mat with a second roller assembly as described above with respect to the first finish composition. For example, the second finish roller can have an uneven surface for depositing the second finish composition on the outer surface of the second fibrous mat on a surface opposite to where the first fibrous mat is disposed. The first and second mats, the first and second finish compositions, and the first and second roller assemblies can be the same or different materials or arrangements.

The cementitious article can be any of any type or shape suitable for a desired application. Non-limiting examples of cementitious articles include gypsum panels and cement panels of any size and shape.

The following examples further illustrate the invention but, of course, should not be construed as in any way limiting its scope. Unless otherwise indicated, the finish composition in the following examples was as set forth in Table 1 below.

TABLE 1

| Ingredient | Wt. % |
|---|---|
| Fly ash Class C | 66.40% |
| Acrylic polymer - FORTON VF 774 Liquid Polymer | 32.81% |
| Colorant - Ajack Black SC | 0.13% |
| Octyl Triethoxysilane - Prosil 9202 | 0.66% |

In the following Examples, the modified ANSI A118.10 test (as it references ASTM D4068) involved a test setup with a two-inch diameter, 48 inch high hollow plastic tube which was firmly secured and sealed to the top surface of the test panel. The tube was filled with tap water to the top height of 48 inches. Drop in water level as a function of time was monitored and recorded, with observations made for water leakage and leakage locations.

### Example 1

This Example illustrates the effect of grit in a hydrophobic finish composition on the water resistance of an article containing such a finish.

A 4 foot by 8 foot glass-mat faced gypsum board (panel) comprising hydrophobic finish with grit therein was prepared. The panel was dragged across another 4 foot by 8 foot glass mat panel of similar composition to simulate field handling conditions. The dragging was done by stacking panels with edges aligned, lifting one 8′ edge about 2′ off the board below, then moving this edge horizontally 2′, thus dragging the other 8′ edge across half the face of the panel beneath. Contact between the panels made in scraped regions was identified by permanent marker and intact regions free from scraping identified by permanent marker.

Two control samples were taken from an intact region of the tested board. Two samples were also taken from the tested board where scraping occurred. The samples had dimensions of 12 inches×12 inches. Each sample was then tested for water resistance in accordance with modified ANSI A118.10 discussed above. The results are plotted in FIG. 3. Scraped sample 1 exhibited water leakage 10 minutes after the test began. In contrast, the control samples did not have water leakage until after 5 days.

This Example shows that grit particles in a hydrophobic finish composition can undesirably compromise water resistance of board containing the finish. For example, when the board is scraped by another board, as might occur during normal handling, the grit can become dislodged and leave a hole in the finish such that water resistance may be adversely affected.

### Example 2

### Comparative

This Example illustrates the application of finish composition of varying degree of stiffness and composition to a glass mat face of gypsum board by the use of a rubber or foamed blade (squeegee), foam strip, or trowel, for comparison purposes.

With respect to the rubber blade technique, a soft rubber floor squeegee, hard rubber floor squeegee, gum rubber floor squeegee, and doubled closed cell foam floor squeegee were tested separately. Hydrophobic finish composition was poured on glass-mat faced gypsum board on an outer surface of the mat. In each test, the aforesaid selected squeegee was used to draw the finish composition across the board surface to spread it. Upon being subjected to the modified ANSI A118.10 test discussed above, water resistance was not sufficient as it was observed that there were small unfinished areas and undesirable pin holes. The desired finish weight could not be achieved with one pass of the squeegee. In addition, some of the finish composition spilled over the edge of the board during application. It has been found that foamed dams can be used on the board edges to contain the slurry but such dams add complexity to the system and the dams tend to become ineffective due to wear from the mats.

In another series of tests, the finish composition was wiped on the outer surface of mat-faced gypsum board by way of a foam strip mounted to a flat surface. Different foams of varying composition, thickness, and stiffness were tried including closed cell and open cell orientations. Hydrophobic finish composition was poured on glass-mat faced gypsum board on an outer surface of the mat. In each test, the foam strip was used to draw the finish composition across the board surface to spread it. Open cell foams were observed to undesirably absorb some of the finish composition which then set or dry within the foam structure, thereby resulting in an uneven finish distribution. Some of the finish composition spilled over the edge of the board during application of the various foam strips.

A trowel device was also tested. The tested trowel is commercially available as “Magic Trowel” by TexMaster Tools. The trowel technique was effective in achieving the desired finish weight. However, the technique was not fully satisfactory because two finishes were required, with drying between finishes, which is time consuming and inefficient.

This Example shows that the use of such blades, foam strips, and trowel can be used but are not fully satisfactory. For example, spillage of finish slurry must be addressed, thereby adding complexity to the manufacturing process, and because application of the finish requires more than one pass under the blade, foam strip, or trowel.

### Example 3

This Example illustrates the application of finish composition to a glass mat face of gypsum board by the use of a finish roller having a smooth (e.g., non-grooved) surface for comparison purposes.

The finish composition of Table 1 was poured on glass-mat faced gypsum board on an outer surface of the mat. Six samples were tested with variation in the settings for the finish roller and doctor roller of the roller assembly. The finish roller was adjusted to various heights relative to The bottom roller. The doctor roller was adjusted to various gaps relative to The finish roller. The samples were tested with varying number of passes. Squeegee was used as a second step after the finish roller was tested in two of the samples (Nos. 3A and 3D). One of the samples (No. 3E) was preheated. The finish regimen for the six samples is set forth in Tables 2A and 2B below.

TABLE 2A

| | | | | Delay | Delay | 1st | 1st |
|---|---|---|---|---|---|---|---|
| | | | | before | before | Pass | Pass |
| | | | | 2nd | 3rd | Doctor | Height |
| | | | # | Pass | Pass | Set | Set |
| Sample | Method | Preheat | finishes | (min) | (min) | (inches) | (inches) |
| 3A | Direct + | No | 1 | | | 0.038 | 0.485 |
| | Squeegee | | | | | | |
| 3B | Direct | No | 2 | 10 | | 0.045 | 0.480 |
| 3C | Direct | No | 2 | 1 | | 0.035 | 0.520 |
| 3D | Direct + | No | 2 | 16 | — | 0.045 | 0.500 |
| | Squeegee | | | | | | |
| 3E | Direct | Yes | 2 | 10 | | 0.040 | 0.495 |
| 3F | Direct | No | 3 | 0 | 0 | 0.030 | 0.500 |

TABLE 2B

| | | | | | | Slurry | |
|---|---|---|---|---|---|---|---|
| | 2nd | 2nd | 3rd | 3rd | Slurry | Added | Final |
| | Pass | Pass | Pass | Pass | Wt 1st | 2nd | Slurry |
| | Doctor | Height | Doctor | Height | Pass, | Pass, | Wt, |
| | Set | Set | Set | Set | (lbs/ | (lbs/ | (lbs/ |
| Sample | (inches) | (inches) | (inches) | (inches) | msf) | msf) | msf) |
| 3A | | | | | 55 | | 55 |
| 3B | 0.030 | 0.500 | | | 53 | 27 | 80 |
| 3C | 0.035 | 0.500 | | | | | 73 |
| 3D | 0.030 | 0.500 | | | 50 | 20 | 70 |
| 3E | 0.040 | 0.495 | | | 50 | 20 | 70 |
| 3F | 0.030 | 0.500 | 0.030 | 0.500 | | | 80 |

After application, the samples were subjected to the modified ANSI A118.10 test discussed above. The results are set forth in FIG. 4 and Table 3 below. The water drop in Table 3 is provided in inches.

TABLE 3

| Days | 3A | 3B | 3C | 3D | 3E | 3F |
|---|---|---|---|---|---|---|
| 2 | −44.750 | −4.000 | −38.125 | −40.000 | −23.250 | −46.750 |
| 5 | −48.000 | −4.188 | −45.063 | −43.000 | −24.375 | −48.000 |
| 27 | −48.00 | −6.38 | −48.00 | −43.50 | −30.00 | −48.00 |

As seen from the results, the samples did not pass the modified ANSI A118.10 test. All samples had water drop after 2 minutes of filling the 48″ column with water. At two days, all samples had significant water leakage up to 46.75.″ For samples 3A and 3C, isolated water droplets appeared on top of the panel composite (bearing the finish) at 14 minutes and 3.5 minutes, respectively. As an illustration, FIG. 5 is provided to show the presence of water droplet on sample 3A. FIG. 6, an optical image for sample 3C at 25×, demonstrates formation of significant number of voids remaining open after the finish was applied, explaining the inadequate water resistance of the sample. There was also an undesirable filtering effect as a higher percentage of liquid than solids from the composition was transferred to the panel, since the glass mat acted as a filter such that much of the solid material remained on the roller instead of being deposited on the panel.

### Example 4

This Example illustrates the application of finish composition to a glass-mat face of gypsum board by the use of a finish roller having even surface in accordance with embodiments of the invention.

The finish composition was poured on glass-mat faced gypsum board on an outer surface of the mat. Seven samples were tested with variation in the settings for the finish roller and doctor roller of the roller assembly. Some of the arrangements were for direct finish orientation and others were set up for reverse finish orientation. The finish roller was adjusted to various heights relative to the bottom roller. The doctor roller was adjusted to various gaps relative to the finish roller. The samples were tested with varying number of passes. Squeegee was used as a second step after the finish roller was tested in two of the samples (Nos. 4B and 4G). The finish regimen for the seven samples is set forth in Tables 4A and 4B below.

TABLE 4A

| | | | 1st Pass | 1st Pass | 2nd Pass |
|---|---|---|---|---|---|
| | | | Doctor | Height | Doctor |
| | | # | Set | Set | Set |
| Sample | Method | Finishes | (inches) | (inches) | (inches) |
| 4A | Reverse | 1 | 0.005 | 0.485 | |
| 4B | Reverse + | 1 | 0.005 | 0.485 | |
| | Squeegee | | | | |
| 4C | Reverse | 1 | 0.005 | 0.470 | |
| 4D | Reverse | 1 | 0.005 | 0.470 | |
| 4E | Direct | 2 | 0.015 | 0.490 | 0.020 |
| 4F | Direct + | 2 | 0.015 | 0.450 | 0.003 |
| | Reverse | | | | |
| 4G | Direct + | 2 | 0.015 | 0.450 | 0.001 |
| | Reverse + | | | | |
| | Squeegee | | | | |

TABLE 4B

| | 2nd Pass | Finish | Finish | Total |
|---|---|---|---|---|
| | Height | Weight | Weight | Finish |
| | Set | 1st pass | 2nd pass | Weight |
| Sample | (inches) | (lb/msf) | (inches) | (lb/msf) |
| 4A | | 123.0 | | 123.0 |
| 4B | | 138.0 | | 138.0 |
| 4C | | 160.0 | | 160.0 |
| 4D | | 83.0 | | 83.0 |
| 4E | 0.490 | 54.0 | 0.042 | 96 |
| 4F | 0.480 | 51.0 | 0.086 | 137 |
| 4G | 0.485 | 54.0 | 0.082 | 136 |

After application, the samples were subjected to the modified ANSI A118.10 test discussed above. The results are set forth in FIG. 7 and Table 5 below. The water drop in Table 5 is provided in inches.

TABLE 5

| Days | 4A | 4B | 4C | 4D | 4E | 4F | 4G |
|---|---|---|---|---|---|---|---|
| 2 | −0.094 | 0.000 | 0.000 | −0.750 | −0.063 | −0.563 | 0.00 |
| 5 | −0.125 | 0.000 | 0.000 | −0.938 | −0.125 | −1.125 | 0.00 |
| 27 | −0.19 | −0.13 | −0.13 | −2.00 | −0.25 | −1.38 | −0.125 |

As seen from the results, water resistance generally was effective with sufficient finish weight. Sample 4D exhibited water leakage two minutes after the test began, but one reason may have been because of the lower finish weight (83 lb/MS F). FIGS. 8A-8B are optical images for samples 4F and 4A, respectively, at 25× magnification. Sample 4A had very small pinholes and was successful. Sample 4F had some larger pinholes for possible water leakage.

This Example shows that the one pass of finish application under reverse orientation, and two passes of finish application under direct orientation achieved the target finish weight and good water resistance. However, reverse finish orientation and multiple passes under the roller are less preferred embodiments. Expected drawbacks with reverse finish include wear and tear of the roller assembly and possibility of incomplete finish weight on the leading end of the panel because of the interaction of the panel leading end and slurry on the finish roll, as well as undesirable spillage at the panel ends. These drawbacks can be addressed, however, by keeping the panels butted end-to-end through the finish roller. Meanwhile, multiple finishes add complexity due to the use of multiple roller assemblies, and efficiency is compromised since the first finish application is dried before application of subsequent layer. It is more desired to reduce the number of steps in the process and to maximize throughput by not requiring intermediate drying steps before a second round of application.

### Example 5

This Example illustrates the application of finish composition to a glass-mat face of gypsum board by the use of a finish roller having uneven surface in a one-finish (one layer) direct finish arrangement in accordance with embodiments of the invention. The finish roller had grooves disposed circumferentially with 10 buttress thread per inch. The finish roller had a hardness of 44 Durometer-Shore A, and was covered with EPDM.

The finish composition was poured on glass-mat faced gypsum board on an outer surface of the mat. Five samples were tested with variation in the settings for the finish roller and doctor roller of the roller assembly. Most of the arrangements were for direct finish orientation with one test set up for reverse finish orientation (sample 5E). The finish roller was adjusted to various height relative to the bottom roller. The doctor roller was adjusted to various gaps relative to the finish roller. The samples were tested with varying number of passes. One of the samples (5C) was preheated prior to application of the finish, while one was subjected to post-heating (5D), meaning all but one sample were air dried, one sample was dried in an oven. The finish regimen for the five samples is set forth in Table 6A and 6B below. The speed ratio signifies the speed of the finish roller relative to the bottom roller.

TABLE 6A

| | | | Sample | | 1st Pass |
|---|---|---|---|---|---|
| | | | Temp | Avg | Doctor |
| | | | before | Thickness | Set |
| Sample | Meth | Note | (° F.) | (inches) | (inches) |
| 5A | Direct | Cntrl | 60 | 0.507 | −0.004 |
| 5B | Direct | Hi Visc | 60 | 0.512 | −0.004 |
| 5C | Direct | Preheat | 158 | 0.508 | −0.004 |
| 5D | Direct | Post | 60 | 0.507 | −0.004 |
| | | heat | | | |
| 5E | Reverse | Reverse | 60 | 0.507 | 0.004 |

TABLE 6B

| | | | Final | |
|---|---|---|---|---|
| | 1st Pass | | Wet | |
| | Height | | Finish | Finish |
| | Set | Speed | wt, | roll gap |
| Sample | (inches) | Ratio | (lbs/msf) | (inches) |
| 5A | 0.490 | 1 | 120 | −0.017 |
| 5B | 0.490 | 1 | 110 | −0.022 |
| 5C | 0.490 | 1 | 110 | −0.018 |
| 5D | 0.490 | 1 | 100 | −0.017 |
| 5E | 0.506 | 3 | 130 | 0.000 |

After application, the samples were subjected to the modified ANSI A118.10 test discussed above. The results are set forth in FIG. 9 and Table 7 below. The water drop in Table 7 is provided in inches.

TABLE 7

| Days | 5A | 5B | 5C | 5D | 5E |
|---|---|---|---|---|---|
| 2 | 0 | 0 | 0 | 0 | 0 |
| 5 | 0 | 0 | 0 | 0 | 0 |
| 27 | −0.125 | −0.063 | 0 | −0.063 | −0.063 |

As seen from the results, the circumferentially grooved finish roller was successful in achieving the desired finish weight with a single pass under the finish roller with direct orientation. The buttress thread is expected to be useful to provide longer service life. The hardness of 50 Durometer-Shore A allowed the finish roller to conform to the inherent irregularities in the panel surface, thereby providing a uniform finish thickness. The roller was substantially clean after depositing the finish on the panel without any filtering effect.

This Example shows that the tests were successful relative to water resistance as all samples showed no water leakage after 9 days. After 26 days of testing, all samples showed excellent water resistance with maximum water drop being 0.125 inch. FIGS. 10A-C are optical images for samples 5A, 5C, and 5E, respectively, at 20× magnification. While the sample 5A has some pinholes, the finish is believed to have penetrated and covered the voids. The finish of samples 5C and 5E had good surface coverage with little or no pinholes.

### Example 6

This Example illustrates drying of the finish composition on the composite article (i.e., after the finish is applied to the mat-faced gypsum board on an outer surface of the mat).

The drying was conducted with convective heat in an oven. Various drying times and durations were trialed in 8 samples, numbered samples 6A-6H. In the series of tests, oven temperatures of 200° F., 300° F., 400° F., and 500° F. were used. In two of the samples, i.e., samples 6G and 6H, pre-heating of the article prior to application of the finish was conducted. The duration of the heating and temperature were recorded for each sample, as set forth in Table 8 below.

TABLE 8

| | Preheat | |
|---|---|---|
| | duration | Oven |
| | (seconds) | temp (° F.) |
| 6A | 0 | 200 |
| 6B | 0 | 200 |
| 6C | 0 | 300 |
| 6D | 0 | 300 |
| 6E | 0 | 400 |
| 6F | 0 | 400 |
| 6G | 45 | 400 |
| 6H | 45 | 400 |

Panel dryness was measured using a moisture meter (GE Protimeter), with a reading of 60 or less regarded as dry. Results of relative moisture readings at the various temperatures and durations for the samples are depicted in FIGS. 11A and 11B. As seen in FIG. 11A, drying at 200° F. or 300° F. took 90 seconds or longer, which is undesirably long because it would require a longer dryer, or lower line speed, resulting in higher capital and/or operating cost. However, use of a temperature of 400° F. was successful in achieving a dry finish in 75 seconds, as seen in FIG. 11B. It has been found that drying the finish too rapidly, using temperature of 500° F., can cause blistering which is harmful to the water resistance property.

Preheating of the panel prior to applying the finish helps the finish dry more rapidly, with less energy input and less residence time in the dryer. In this regard, it has been found that heating the panel through the gypsum core is more effective than heating only the surface to be finished.

Water resistance was tested for the samples according to the modified ANSI A118.10 test discussed above. The results are set forth in FIG. 12 and Table 9 below.

TABLE 9

| Days | 6E | 6F | 6G | 6H |
|---|---|---|---|---|
| 2 | 0 | −0.25 | 0 | 0 |
| 5 | −0.188 | −0.313 | −0.031 | −0.125 |
| 27 | −2.5 | −0.5 | −0.125 | −0.313 |

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method of preparing a mat-faced cementitious article composite comprising:
(a) preparing a mat-faced gypsum article, wherein the mat has an inner surface adjacent to a cementitious core first surface and an opposite outer mat surface; and
(b) applying an aqueous cementitious finish composition to the outer mat surface to form the mat-faced cementitious article composite.

2. The method of claim 1, wherein the mat-faced cementitious article composite further comprises a second mat on an opposite second surface of the core, and wherein the core optionally comprises a skim coat in contact with the inner mat surface of one or both mats.

3. The method of claim 1, wherein the finish composition is applied with a roller assembly comprising a finish roller for depositing the finish composition on the outer surface of the fibrous mat.

4. The method of claim 3, wherein the finish roller has an uneven surface.

5. The method of claim 4, wherein the finish roller surface defines at least one groove therein.

6. The method of claim 5, the finish roller having a longitudinal axis, wherein the groove(s) are substantially perpendicular to the axis at a depth from about 0.001 inch to about 0.25 inch and/or wherein the grooves have a width from about 0.001 inch to about 0.25 inch.

7. The method of claim 5, wherein the finish roller comprises a buttress thread form to define the grooves.

8. The method of claim 7, wherein the finish roller has between about 4 to about 50 buttress thread per longitudinal inch.

9. The method of claim 4, wherein the finish roller has a hardness of about 100 Durometer or less as determined according to Shore-A.

10. The method of claim 4, wherein the roller assembly further comprises a bottom roller that engages with a second surface of the article opposite of the outer surface, and wherein the finish roller rotates in the same direction as the article moves.

11. The method of claim 4, wherein the finish roller rotates in reverse so that its surface in contact with the article is moving in the opposite direction as the article moves.

12. The method of claim 4, wherein the roller assembly further comprises a doctor roller, wherein the doctor roller mates with the finish roller to define a trough therebetween, wherein the doctor roller rotates in an opposite direction than the finish roller rotates.

13. The method of claim 4, wherein the finish composition is applied with only one pass under the finish roller.

14. The method of claim 1, wherein the finish composition is applied in an amount from about 10 lb/msf to about 200 lb/msf.

15. The method of claim 1, further comprising preparing the cementitious finish composition, wherein the preparing comprises forming a slurry comprising cementitious material, water, and optionally one or more other ingredients in a continuous, co-rotating overlapping twin screw mixer.

16. The method of claim 1, further comprising preparing the cementitious finish composition, wherein the preparing comprises passing one or more components through a screen having a size from about 12 mesh to about 100 mesh.

17. The method of claim 1, further comprising drying the finish composition with radiant and/or convection heating at a temperature from about 200° F. (≈93° C.) to about 600° F. (≈316° C.) for a time duration from about 15 seconds to about 120 seconds.

18. The method of claim 17, wherein the article is preheated until the surface temperature is at least about 80° F., prior to applying the finish composition.

19. The method of claim 1, wherein the article is formed into a board that passes the test for waterproofness per ANSI A118.10 (according to ASTM D4068) and/or a modified ANSI A118.10, wherein 48 inch hydrostatic pressure is applied for 48 hours, with a water level drop of about 1/32 inch or less.

20. The method of claim 1, further comprising applying a second finish composition on an outer surface of a second fibrous mat with a second roller assembly comprising a finish roller having an uneven surface for depositing the second finish composition on an outer surface of the second fibrous mat on a core surface opposite to where the first fibrous mat is disposed, wherein the first and second mats, the first and second finish compositions, and the first and second roller assemblies are the same or different.
